(19) United States
(12) Patent Application Publication
(10) Pub. No.: US 2022/0082431 A1
(43) Pub. Date: Mar. 17, 2022

(54) Portable Scale

(71) Applicant: Dongguan Poheng Electronics Co., Ltd., Dongguan (CN)

(72) Inventor: Yilian Qiu, Yangchun (CN)

(21) Appl. No.: 17/239,602

(22) Filed: Apr. 25, 2021

(30) Foreign Application Priority Data
Sep. 14, 2020 (CN) 202022008911.2

(51) Int. Cl. G01G 19/50; G01G 19/52

(52) U.S. Cl. CPC G01G 19/50; G01G 19/52

(57) ABSTRACT

The present invention discloses a portable scale, which includes a housing, an upper cover, a display, a panel, a weighing sensor with a bottom and a top, a first bracket, a second bracket, a scale plate, a PCB plate and a battery; the housing is hinged with the upper upper cover to form a box body; the weighing sensor, the PCB plate, the battery, the display, the first bracket and the second bracket are arranged in the housing; the first bracket, the second bracket are arranged on the bottom and the top of the weighing sensor, respectively; the first bracket is fixed in the housing; the panel covers the housing; the panel is provided with two avoiding positions for avoiding the display and the weighing sensor; the scale plate is fixed on the second bracket through one of the avoiding position; the weighing sensor.

### FIELD OF THE INVENTION

The present invention relates to portable scale, more particularly to a portable scale.

### BACKGROUND OF THE INVENTION

Electronic scale is a kind of weighing instrument, it is a tool for measuring the mass of an object using Hooke's law or the lever balance principle of force. According to the principle of structure, it can be divided into three categories: mechanical scale, electronic scale and electromechanical scale. Because of the large volume, heavy weight, and shape design, most of the existing electronic scales are inconvenient to carry which results in inconvenience to use.

### SUMMARY OF THE INVENTION

The object of the present invention is to provide a portable scale, to solve the technical problem of the electronic scale in the prior art which is inconvenient to carry.

In order to achieve the object of the present invention, the technical schemes are as follows:

A portable scale includes a housing, a upper cover, a display, a panel, a weighing sensor with a bottom and a top, a first bracket, a second bracket, a scale plate, a PCB (Printed Circuit Board) plate and a battery; the housing is hinged with the upper upper cover to form a box body; the weighing sensor, the PCB plate, the battery, the display, the first bracket and the second bracket are arranged in the housing; the first bracket, the second bracket are arranged on the bottom and the top of the weighing sensor, respectively; the first bracket is fixed in the housing; the panel covers the housing; the panel is provided with two avoiding positions for avoiding the display and the weighing sensor; the scale plate is fixed on the second bracket through one of the avoiding position; the weighing sensor, the display and the battery are electrically connected with the PCB plate.

The portable scale also includes a lower cover, the bottom of the housing is provided with a battery slot, the battery is detachably installed in the battery slot; the lower cover is fastened on the bottom of the housing to cover the battery slot.

The bottom of the housing is provided with a receiving slot for placing a weight; the lower cover is fastened on the bottom of the housing for covering the receiving slot.

The lower cover and the housing are connected by sliding buckles.

The upper cover is detachable with the housing.

The housing extends outward with at least one first connecting part with two ends, one end of the first connecting part is provided with a connecting hole; the housing is also provided with a first avoiding slot at the connecting holes; the upper cover extends outwards with at least one second connecting part corresponding to the first connecting part, the second connecting part is provided with a connecting shaft; the upper cover is provided with an avoiding gaps at the connecting shaft; the other end of the first connecting part is provided with a second avoiding slots; when assembled, the second avoiding slots avoids the upper cover, the first avoiding slots avoids the second connection part, and the avoiding gap avoids the first connection part.

The length of the first avoiding slot is greater than the length of the second connecting part pluses that of the connecting shaft.

The length of the avoiding gap is greater than that of the first connecting part.

One or more of the above technical schemes in the portable scale provided by the embodiment of the invention have at least one of the following technical effects: When the portable scale is used, because the housing and the upper cover is hinged, the upper cover can be easily opened and does not separate from the housing. The objects needed to be weighed are placed on the scale plate, the panel is used to fix the display and the PCB plate, and the panel is fixed with the housing. After the scale plate suffers force, as the weighing sensor is arranged under the scale plate, the weighing sensor is fixed by the first first bracket and the second bracket, thus the weighing sensor is not easily move, which ensure the accuracy of weighing. The weighing sensor suffers the pressure and transmits the electrical signal to the PCB plate, and the PCB plate controls the display to display the pressure information, thereby realizing weighing. The battery supplies electricity to the portable scale. When the portable scale is used, the upper covers covers the housing to form a whole, so that it is easy to carry.

### BRIEF DESCRIPTION OF THE DRAWINGS

In order to explain more clearly the technical scheme in the embodiments of the invention, a brief introduction is given below to the attached drawings needed in the embodiments or the prior art description. Obviously, the attached drawings in the following description are only some embodiments of the invention. For ordinary technicians in this field, other drawings can be obtained according to these drawings without paying creative labor.

FIG. 1 is a perspective view of the portable scale according to the invention.

FIG. 2 is the other perspective view of the portable scale in another angle of view according to the invention.

FIG. 3 is a perspective view of the housing 10 according to the invention.

FIG. 4 is the other perspective view of the housing 10 according to the invention. In order to show the structure clearly, the lower cover 30 and the bottom 10a of the housing 10 are removed in FIG. 4.

FIG. 5 is a perspective view of the upper cover 20 according to the invention.

FIG. 6 is the other perspective view of the housing 10 according to the invention. In order to show the structure clearly, the lower cover 30 is removed in FIG. 6.

### EMBODIMENTS

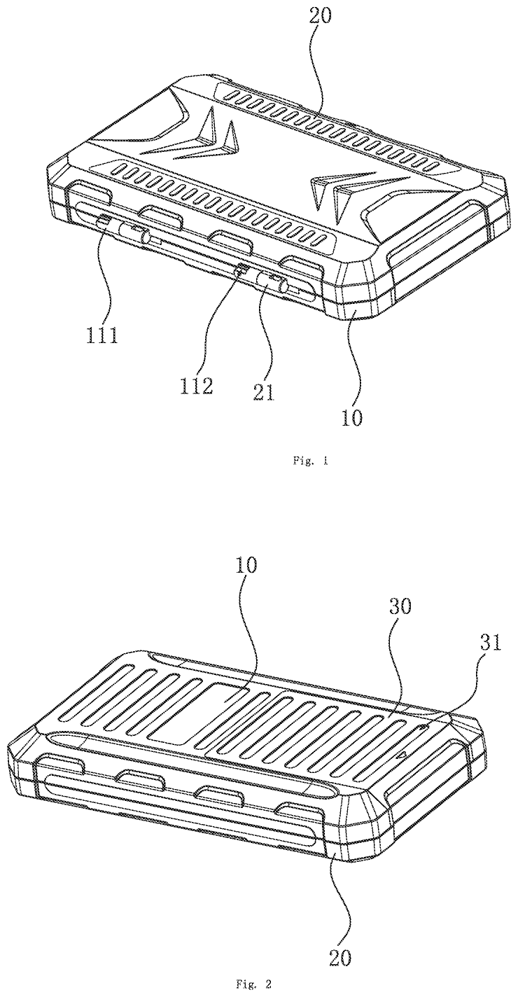

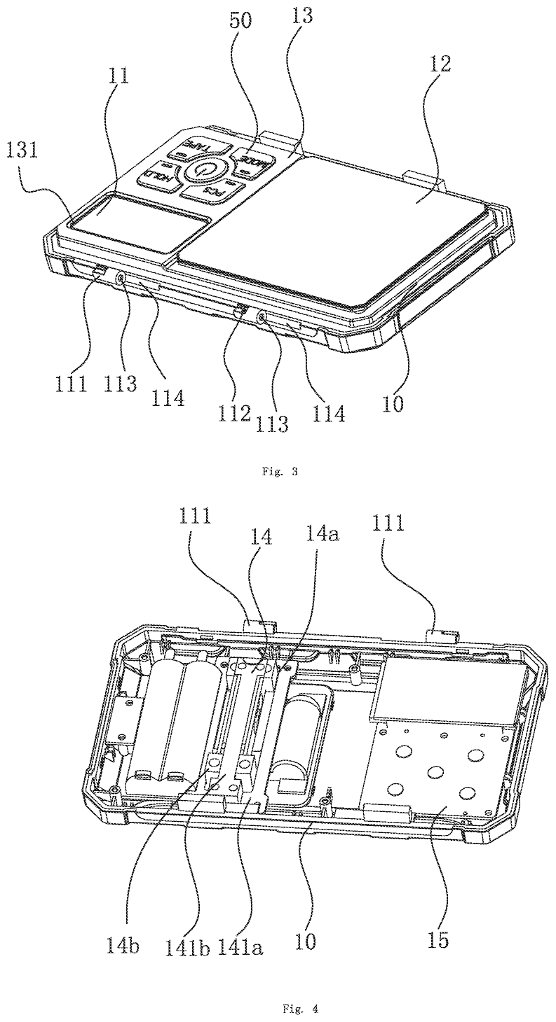

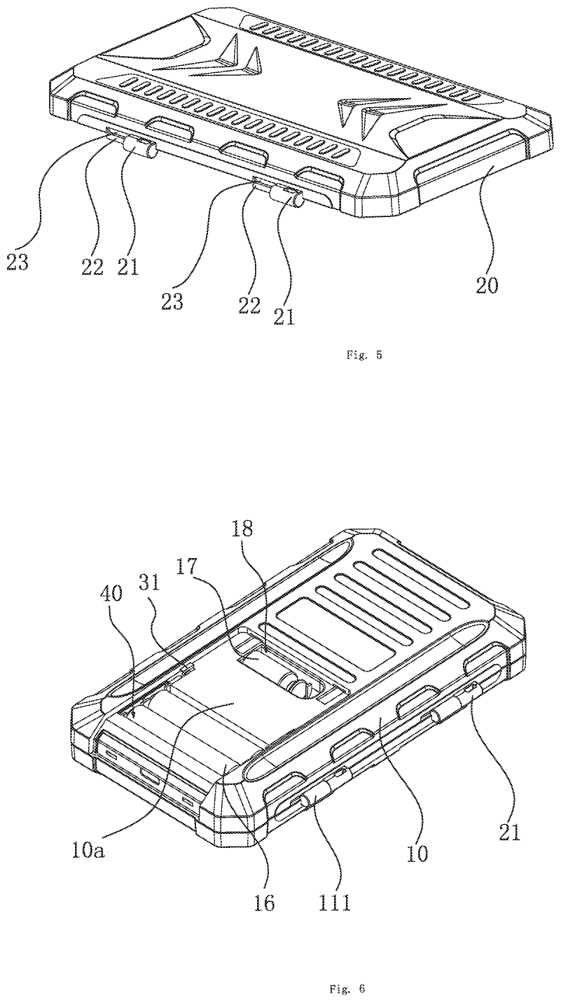

The embodiments of the present invention are described in details below, and the embodiments are shown in the attached figures, where the same or similar label from beginning to end represents the same or similar element or element with the same or similar function. The embodiments described below by reference to FIGS. 1-6 are exemplary and are intended to be used to explain embodiments of the present invention and can not be understood as limitations to the present invention.

In the description of the embodiment of the present invention, it needs to be understood that the azimuth or position relation indicated in the terms “length “,” width “,” upper “,” lower “,” front “,” rear “,” left “,” right “,” vertical “,” horizontal “,” top “,” bottom” inside “,” outside “and so on are based on the azimuth or position relation shown in the attached drawing, only for the convenience of describing the embodiment of the present invention and simplifying the description, rather than indicating or implying that the device or element must have a specific orientation, with a specific orientation and operation, so it can not be understood as a limitation to the present invention.

Furthermore, the terms “first “,” second” are used only for descriptive purposes and it can not be understood as indicating or implying relative importance or implicitly the number of technical features indicated. Thus, the qualification of “first” and “second” features may include one or more of them explicitly or implicitly. In the description of the embodiments of the invention, the meaning of “multiple” is two or more, unless otherwise specified.

In the embodiment of the invention, unless other specified and qualified, the terms “installation “,” connection “,,” fixed” and other terms shall be broadly understood, for example, it may be fixed connection, detachable connection, or integration; it may be mechanical connection or electrical connection; it may be directly connected or indirectly connected by intermediate media, it may be internal connection of two components or the interaction of two components. For ordinary technicians in the field, the specific meaning of the above term in the embodiment of the invention can be understood according to the specific circumstances.

In one embodiment according to the present invention, referring to FIGS. 1-6, the portable scale includes a housing 10, a upper cover 20, a display 11, a panel 13, a weighing sensor 14 with a bottom 14a and a top 14b, a first bracket 141a, a second bracket 141b, a scale plate 12, a PCB plate 15 and a battery 16. The housing 10 is hinged with the upper upper cover 20 to form a box body. The weighing sensor 14, the PCB plate 15, the battery 16, the display 11, the first bracket 141a and the second bracket 141b are arranged in the housing 10. The first bracket 141a, the second bracket 141b are arranged on the bottom 14a and the top 14b of the weighing sensor 14, respectively. The first bracket 141a is fixed in the housing 10. The panel 13 covers the housing 10. The panel 13 is provided with two avoiding positions 131 for avoiding the display 11 and the weighing sensor 14. The scale plate 12 is fixed on the second bracket 141b through one of the avoiding position 131. The weighing sensor 14, the display 11 and the battery 16 are electrically connected with the PCB plate 15.

Concretely, the portable scale in an embodiment according to the present invention is using, because the housing 10 and the upper cover 20 is hinged, the upper cover 20 can be easily opened, and the housing 10 and the upper cover 20 can not be separated. The scale plate 12 is used for placing the weighing objects, the panel 13 is used for fixing the display 11 and the PCB plate 15, and the panel 13 is fixed with the housing 10. After the scale plate 12 is forced, as the weighing sensor 14 is arranged at the bottom of the weighing plate 12 and is fixed via the first bracket 141a and the second bracket 141b, so that the the weighing sensor 14 is not easily moved, which promises the accuracy of weighing. The weighing sensor 14 suffers the pressure and transmits the electrical signal to the PCB plate 15, and the PCB plate 15 controls the display 11 to display the pressure information, thereby realizing weighing. The battery 16 supplies electricity to the portable scale. When the portable scale is used, the upper covers 20 covers the housing 10 to form a whole, so that it is easy to carry.

Further, the upper cover 20 and the housing 10 is connected by a magnet, so that the upper cover 20 and the bottom housing 10 are locked.

In the other embodiment according to the present invention, referring to FIG. 2 and FIG. 6, the portable scale also includes a lower cover 30. The bottom 10a of the housing 10 is provided with a battery slot 40, the battery 16 is detachably installed in the battery slot 40. The lower cover 30 is fastened on the bottom 10a of the housing 10 and used for covering the battery slot 40. Concretely, when the battery 16 is dead, the bottom cover 30 is removed from the bottom 10a of the housing 10, then the battery 16 is replaced and then the bottom cover 30 is fastened to the housing 10. The lower cover 30 can protect the battery 16 every well and ensure that the battery 16 is easy to replace, not easy to fall out of the housing 10.

In the other embodiment according to the present invention, referring to FIG. 2 and FIG. 6, the bottom 10a of the housing 10 is provided with a receiving slot 18 which is used for placing a weight 17. The lower cover 30 is fastened on the bottom 10a of the housing 10, which is used for covering the battery slot 40 and the receiving slot 18. Concretely, when it is necessary to check whether the weighing of the portable scale is accurate, remove the bottom cover 30 from the bottom shell 10, then remove the weight 17 placed in the receiving slot 18, and place the weight 17 on the scale plate 12, observe whether the weight displayed by display 11 is consistent with the weight marked by weight 17, thereby knowing whether the weight of the portable scale is accurate.

In the other embodiment according to the present invention, referring to FIG. 2 and FIG. 6, the lower cover 30 and the housing 10 are connected by sliding buckles 31. Concretely, the lower cover 30 is pushed outwards to be separated from the bottom of the housing 10.

In the other embodiment according to the present invention, the upper cover 20 is detachable with the housing 10. Concretely, because the housing 10 and the upper cover 20 are detachable, the upper cover 20 is separated from the housing 10, and the upper cover 20 can be used as a weighing plate to load items for weighing.

In the other embodiment according to the present invention, referring to FIGS. 1-6, one side of the housing 10 extends outward with at least one first connecting part 111 with opposing two ends, one end of the first connecting part 111 is provided with a connecting hole 113. The side of the housing 10 is also provided with a first avoiding slot 114 at the connecting holes 113. A side of the upper cover 20 extends outwards with at least one second connecting part 21 corresponding to the first connecting part 111, the second connecting part 21 is provided with a connecting shaft 22. The upper cover 20 is provided with an avoiding gaps 23 at the connecting shaft 22.

The other end of the first connecting part 111 is provided with a second avoiding slots 112. When assembled, the second avoiding slots 112 is used to avoid the right angle of the side of the upper cover 20, the first avoiding slots 114 is used to avoid the second connection part 21, and the avoiding gap 23 is used to avoid the first connection part 21. Concretely, the first connecting part 111 is fixed at the side of the housing 10 and is formed in a whole with the housing 10, and the connecting shaft 22 is formed in a whole with the second connecting part 21. When assembled, one side of the connecting shaft 22 is aligned to the corresponding connecting hole 113, then the second avoiding slot 112 avoids the right angle on the side of upper cover 20, the first avoiding slot 114 avoids the second connecting part 21, the upper cover 20 is pulled, the second connecting part 21 is slided in the first avoiding slot 114 so that the connecting shaft 22 enters the connecting hole 113, the first connecting part 111 is arranged in the avoiding gap 23, thus the housing 100 is connected with the upper cover 20.

In the other embodiment according to the present invention, referring to FIGS. 1-6, the length of the first avoiding slot 114 is greater than the length of the second connecting part 21 pluses that of the connecting shaft 22, which ensures that when assembled, the first avoiding slot 114 can avoid the second connecting part 21.

In the other embodiment according to the present invention, referring to FIGS. 1-6, the length of the avoiding gap 23 is greater than that of the first connecting part 111, which ensures that when assembled, the connecting shaft 22 is fully extended into the connecting hole 113, and the avoiding gap 23 can avoid the first connecting part 111.

In the other embodiment according to the present invention, referring to FIG. 2, the lower cover 30 is provided with a plurality of horizontally arranged strip grooves 31, each of the strip grooves 31 is arranged in parallel intervals on the surface of the lower cover 30. Concretely, the plurality of strip grooves 31 increases friction, allowing users to easily separate the lower cover 30 from the housing 10 by hand.

In the other embodiment according to the present invention, referring to FIG. 3, the portable scale also includes keys 50 mounted on the panel 13, the keys 50 pass through the panel 13 to connect with the PCB plate 15. Users can operate the portable scale by the key 15, which increases the practicability of portable scale.

The above is only a better embodiment of the utility model and is not used to limit the utility model. Any modification, equivalent replacement and improvement made within the spirit and principles of the utility model shall be included in the protection scope of the utility model

1. A portable scale, comprising: a housing, a upper cover, a display, a panel, a weighing sensor with a bottom and a top, a first bracket, a second bracket, a scale plate, a PCB plate and a battery; said housing is hinged with said upper upper cover to form a box body; said weighing sensor, said PCB plate, said battery, said display, said first bracket and said second bracket are arranged in said housing;
said first bracket, said second bracket are arranged on said bottom and said top of said weighing sensor, respectively; said first bracket is fixed in said housing; said panel covers said housing; said panel is provided with two avoiding positions for avoiding said display and said weighing sensor; said scale plate is fixed on said second bracket through one of said avoiding position; said weighing sensor, said display and said battery are electrically connected with said PCB plate.

2. The portable scale according to claim 1, wherein also comprising a lower cover, said bottom of said housing is provided with a battery slot, said battery is detachably installed in said battery slot; said lower cover is fastened on said bottom of said housing to cover said battery slot.

3. The portable scale according to claim 2, wherein also comprising said bottom of said housing is provided with a receiving slot for placing a weight; said lower cover is fastened on said bottom of said housing to cover said receiving slot.

4. The portable scale according to claim 1, wherein said lower cover and said housing are connected by sliding buckles.

5. The portable scale according to claim 1, wherein said upper cover is detachable with said housing.

6. The portable scale according to claim 1, wherein said housing extends outward with at least one first connecting part with two ends, one end of said first connecting part is provided with a connecting hole; said housing is also provided with a first avoiding slot at said connecting holes; said upper cover extends outwards with at least one second connecting part corresponding to said first connecting part, said second connecting part is provided with a connecting shaft; said upper cover is provided with an avoiding gaps at said connecting shaft; said said end of said first connecting part is provided with a second avoiding slots; when assembled, said second avoiding slots avoids said upper cover, said first avoiding slots avoids said second connection part, and said avoiding gap avoids said first connection part.

7. The portable scale according to claim 6, wherein said length of said first avoiding slot is greater than said length of said second connecting part pluses that of said connecting shaft.

8. The portable scale according to claim 6, wherein said length of said first avoiding slot is greater than said length of said second connecting part pluses that of said connecting shaft.
